(19) United States
(12) Patent Application Publication
(10) Pub. No.: US 2013/0196173 A1
(43) Pub. Date: Aug. 1, 2013

(54) Organic Corrosion Inhibitor-Embedded Polymer Capsule, Preparation Method Thereof, Composition Containing Same, and Surface Treated Steel Sheet Using Same

(71) Applicants: Ji Hoon Park, Jinju-si (KR); Jae Ryung Lee, Gwangyang-si (KR); Chang Hoon Choi, Gwangyang-si (KR); Jong Myung Park, Pohang-si (KR)

(72) Inventors: Ji Hoon Park, Jinju-si (KR); Jae Ryung Lee, Gwangyang-si (KR); Chang Hoon Choi, Gwangyang-si (KR); Jong Myung Park, Pohang-si (KR)

(73) Assignees: POSTECH ACADEMY-INDUSTRY FOUNDATION, Pohang-si (KR); POSCO, Pohang-si (KR)

(21) Appl. No.: 13/640,159

(22) PCT Filed: Apr. 9, 2010
(86) PCT No.: PCT/KR2010/002183

§ 371 Date: Jan. 24, 2013

(51) Int. Cl. C23F 11/167; B29C 67/24

(52) U.S. Cl. CPC C23F 11/1673; B29C 67/247
USPC 428/623; 428/327; 428/626; 264/4.1; 252/396; 252/389.24

(57) ABSTRACT

Provided are a polymer capsule in which an organic corrosion inhibitor is encapsulated, a method of preparing the same, a composition having the same, and a steel sheet whose surface is treated using the same. The polymer capsule prepared to include a core layer polymer having a hydrophilic acid group and at least one shell layer surrounding the core layer through continuous emulsion polymerization may have an organic corrosion inhibitor effectively encapsulated. The corrosion inhibitor may be released from the capsule in a corrosive environment, thereby enhancing corrosion resistance of the steel sheet.

### TECHNICAL FIELD

The present invention relates to an organic corrosion inhibitor-encapsulated polymer capsule, preparation method thereof, composition containing same and surface treated steel sheet using same.

### BACKGROUND ART

Development of a reactive minute polymer capsule filled with a corrosion inhibitor is a notion inspired by self-healing coating for controlling corrosion. In this hypothesis, science and technology of a new self-healing polymer material are disclosed, and in detail, a minute polymer capsule filled with a corrosion inhibitor was prepared and used in protective coating.

Corrosion inhibitor pigments such as chromate are usually involved in the coating for corrosion protection. A high-performance corrosion inhibitor pigments are usually consisted of a heavy metal and inorganic salts which are under the discussion because of its toxicity to human and environment. Hence, organic corrosion inhibitors are suggested because of low toxicity and moderate corrosion protection performance. To incorporate the organic corrosion inhibitor into the coating, a carrier, which can store and release the materials on demand, is required to be developed. Many strategies such as using nanoporous layers, ion-exchangers and nanocontainers have recently been suggested to impart an active protection component to different coatings. However, these methods are difficult to approach and the efficiency is comparatively low. Sometimes, the materials preserving the active inhibitors are too large to load in the thin coating film.

### DISCLOSURE

### Technical Problem

The present invention is directed to providing a polymer capsule including an organic corrosion inhibitor, a method of preparing the same, a coating composition including the polymer capsule, and a steel sheet coated with the coating composition and thus having excellent corrosion resistance in a corrosive environment.

### Technical Solution

In one aspect, the present invention provides a polymer capsule, comprising:

a core layer polymer polymerized from a monomer including a hydrophilic acid monomer; and

at least one shell layer polymer surrounding the core,

wherein an organic corrosion inhibitor is encapsulated in the core layer or shell layer polymer.

In another aspect, the present invention provides a method of preparing a polymer capsule, comprising:

preparing a core layer polymer polymerized from a monomer including a hydrophilic acid monomer; and

forming a shell layer polymer by adding an organic corrosion inhibitor and a hydrophobic monomer in the presence of the core layer polymer, and

encapsulating the organic corrosion inhibitor in a core layer or shell layer polymer.

In still another aspect, the present invention provides a method of preparing a polymeric hollow particle, comprising:

preparing a core layer polymer polymerized from a monomer including a hydrophilic acid monomer;

forming a shell layer polymer by adding an organic corrosion inhibitor and a hydrophobic monomer in the presence of the core layer polymer, and encapsulating the organic corrosion inhibitor in a core layer or shell layer polymer; and

adding a base compound in the presence of the shell layer polymer.

In yet another aspect, the present invention provides a method of forming a pore in a surface of a polymeric hollow particle, comprising:

preparing a core layer polymer polymerized from a monomer including a hydrophilic acid monomer; and

forming a shell layer polymer by adding an organic corrosion inhibitor, a base compound and a hydrophobic monomer in the presence of the core layer polymer, and encapsulating the organic corrosion inhibitor in a core layer or shell layer polymer.

In yet another aspect, the present invention provides a corrosion-resistant coating composition, comprising:

a polymer capsule according to claim 1; and

a base resin composition.

In yet another aspect, the present invention provides a corrosion-resistant steel sheet with a corrosion resistant resin layer formed on one or both surfaces of the steel sheet by coating the corrosion-resistant coating composition according to claim 9.

### Advantageous Effects

A polymer capsule according to the present invention may be prepared by continuous emulsion polymerization, thereby encapsulating an organic corrosion inhibitor forming a stable passivation film on a metal substrate. The polymer capsule has a small size of several hundreds of nanometers, which is suitable to be mixed in a thin coating film, and its preparation process is relatively simple and fast.

### DESCRIPTION OF DRAWINGS

FIG. 1 shows TEM images of polymer particles according to the present invention, in which (a) is a core polymer particle including a carboxylic acid group, (b) is a core particle surrounded by a relatively hydrophobic acrylate copolymer layer, (c) is a synthetic core-shell polymeric hollow particle surrounded by polystyrene, and (d) is a polymeric hollow particle expanded after neutralization with 28% aqueous ammonia solution;

FIG. 2 shows TEM images of a polymer capsule according to the present invention before and after neutralization of a core by adding a base compound to an emulsion including an organic corrosion inhibitor in the initial stage of polymerization, in which (a) and (b) are phosphoric acid di-butyl ester, (c) and (d) are phosphoric acid 2-ethylhexyl (mono-, di-mixture) ester, and (e) and (f) are phosphoric acid di(2-ethylhexyl) ester;

FIG. 3 shows (A) representative DSC and TGA curves for a polymer capsule according to the present invention, which includes phosphoric acid di(2-ethylhexyl) ester, and (B) the relative contents of phosphoric acid partial ester in various capsules (a) not neutralized, neutralized by simultaneously adding (b) ammonia, (c) DMEA and (d) TEA, or neutralized by sequentially adding (e) ammonia, (f) DMEA and (g) TEA;

FIG. 4 shows TEM images of polymer capsules according to the present invention, in which an organic corrosion inhibitor prepared by adding different kinds of base compounds after the polymerization of a hydrophobic monomer is encapsulated, in which the base compounds are (a) 28% aqueous ammonia solution, (b) 20% aqueous DMEA solution, and (c) 20% aqueous TEA solution;

FIG. 5 shows an adsorption-release isotherm of nitrogen on a polymer capsule according to the present invention, an inner graph being a BJH graph showing pore size distribution when neutralization is performed by adding 28% aqueous ammonia solution, 20% aqueous DMEA solution, or 20% aqueous TEA solution after the polymerization of styrene;

FIG. 6 shows SEM images and TEM images (inside) of polymeric hollow particles including phosphoric acid 2-ethylhexyl ester (mono-, di-mixture) prepared by adding base compounds during (right) or after (left) the polymerization of a hydrophobic monomer according to the present invention, in which (a) and (b) are 28% aqueous ammonia solution, (c) and (d) are 20% aqueous DMEA solution, and (e) and (f) are 20% aqueous TEA solution;

FIG. 7 shows surface areas of polymers calculated by a BET graph of a nitrogen adsorption-release isotherm of polymeric hollow particles prepared by adding different kinds of base compounds during (black) or after (white) the polymerization of a hydrophobic monomer according to the present invention, in which the areas represent the results obtained by adding , (1) is un-treated, (2) and (3) are 28% aqueous ammonia solution, (4) and (5) are 20% aqueous DMEA solution, and (6) and (7) are 20% aqueous TEA solution, respectively;

FIG. 8 shows an adsorption-release isotherm of nitrogen on a polymer capsule according to the present invention, an inner graph being a BJH graph showing pore size distribution when neutralization is performed by adding 20% aqueous DMEA solution after or during the polymerization of styrene;

FIG. 9 shows surfaces of a cold-rolled steel sheet before and after a corrosion solution is continuously dropped on a damaged part every 5 hours, in which (a) is a surface coated with a normal coating not including phosphoric acid partial ester and (b) is a surface coated with a coating including a self-healing capsule including di(2-ethylhexyl) ester; and

FIG. 10 is a graph showing pH-dependent release behavior of a polymer capsule according to the present invention including phosphoric acid di(2-ethylhexyl) ester.

### MODE FOR INVENTION

Hereinafter, the composition of the present invention will be described in detail.

The present invention relates to 1 polymer capsule, comprising:

a core layer polymer polymerized from a monomer including a hydrophilic acid monomer; and

at least one shell layer polymer surrounding the core,

wherein an organic corrosion inhibitor is encapsulated in the core layer or shell layer polymer.

The organic corrosion inhibitor may form a stable passivation film on a metal substrate formed of iron, aluminum or zinc, and may be released from the polymer capsule according to the present invention due to a pH change in a corrosive environment when being used as a coating for a steel sheet, thereby enhancing corrosion resistance of the steel sheet.

As the organic corrosion inhibitor, a phosphoric acid-based corrosion inhibitor, a phosphonic acid-based corrosion inhibitor, a carboxyl group-containing corrosion inhibitor or an azole-based corrosion inhibitor may be used alone or in combination of at least two thereof.

The phosphoric acid-based corrosion inhibitor may use a compound represented by Formula 1.

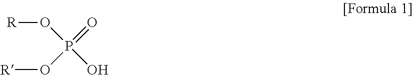

In Formula 1, R and R′ are each independently hydrogen, C₁₋₃₀ alkyl or cycloalkyl, or substituted or unsubstituted phenyl.

The phosphonic acid-based corrosion inhibitor may be aminotris(methylenephosphonic acid), ethylenediamine tetra(methylene phosphonic acid), nitrilo-tris-phosphonic acid, glycine-N,N-di(methylene phosphonic acid), imino-N,N-diacetic-N-methylene phosphonic acid, ethylenediamine tetraphosphonic acid, or hydroxyethane 1,1′-diphosphonic acid, which may be used alone or in combination of at least two thereof.

The carboxyl group-containing corrosion inhibitor may be hexamethylenediamine tetraacetic acid, diethylenetiamine-N,N,N′,N″,N″-pentaacetic acid, or nitrilo-tris-acetic acid, which may be used alone or in combination of at least two thereof.

The azole-based corrosion inhibitor may be 2-amino-5-ethylthio-1,3,4-thiadiazole, 2-amino-5-ethyl-1,3 ,4-thiadiazole, 5-(phenyl)-4H- 1,2,4-triazole-3-thiol, 5-benzylidene-2,4-dioxotetrahydro-1,3-thiazole, 5-(4′-isopropyl benzylidene)-2,4-dioxotetrahydro-1,3-thiazole, 5-(3′-thenylidene)-2,4-dioxotetrahydro-1,3-thiazole, 5-(3′,4′-dimetoxybenzylidene)-2,4-dioxotetrahydro-1,3-thiazole, 5-mercapto-1 phenyl-tetrazole, 2-mercaptobenzothiazole, 3-benzylidene amino 1,2,4-triazole phosphonate, 3-cinnamyledene amino 1,2,4-triazole phosphonate, 3-salicylalidene amino 1,2,4-triazole phosphonate, 3-paranitro benzylidene amino 1,2,4-triazole phosphonate, 1,2,4-triazole 3-amino 1,2,4-triazole, 3-amino mercapto 1,2,4-triazole, 3-amino 5-methylthio 1,2,4-triazole, or cetyl trimethyl ammonium bromide, which may be used alone or in combination of at least two thereof.

The polymer capsule according to the present invention may be composed of a core layer polymer containing a hydrophilic acid, and at least one shell layer polymer surrounding the core, and have an organic corrosion inhibitor encapsulated in the core layer or shell layer polymer depending on a partition coefficient of the polymer.

In other words, the organic corrosion inhibitor may be added to a polymer emulsion, and encapsulated in a polymer having a similar partition coefficient.

According to an exemplary embodiment of the present invention, since phosphoric acid dibutyl ester and phosphoric acid mono ethylhexyl ester, which are phosphoric acid-based corrosion inhibitors, have a partition coefficient of 1.65 and 1.64, respectively, they may be encapsulated in the core layer polymer having a partition coefficient of 2.35. In addition, since phosphoric acid diethylhexyl ester has a partition coefficient of 5.15, it may be disposed in a middle layer having a partition coefficient of 4.02, or the outermost shell layer having a partition coefficient of 10.82.

In addition, while the content of the organic corrosion inhibitor disposed in the core layer or shell layer polymer may be changed according to the type of use and a base resin, the content may be 0.5 mol or more, and preferably, 0.6 to 0.9 mol based on 1 mol of an acid functional group of the core layer polymer. When the content is less than 0.5 mol, a corrosive effect may be degraded.

The hydrophilic acid monomer may be any one including a hydrophilic reactive group capable of maintaining a thermodynamic equilibrium state with a hydrophilic alkali-swelling type shell without limitation, and may include ethylenic unsaturated carboxylic acid, mono alkyl ester of an unsaturated carboxylic acid or vinyl benzoic acid.

The ethylenic unsaturated carboxylic acid may include an acrylic acid, a methacrylic acid, a crotonic acid, an itaconic acid, a fumaric acid, or a maleic acid, and the mono alkyl ester of an unsaturated carboxylic acid may include monoalkyl maleate, monoalkyl fumarate, or monoalkyl itaconate. However, the present invention is not limited thereto.

In addition, the core is a spherical nano particle forming a micelle, in which an organic corrosion inhibitor is encapsulated. The core is preferably an amphiphilic polymer having affinity with a shell surrounding the core.

Therefore, the core layer polymer may use a polymer polymerized from a hydrophilic acid monomer, or a copolymer of a hydrophilic acid monomer and an ethylenic unsaturated monomer.

The ethylenic unsaturated monomer may be, but is not particularly limited to, a C₁₋₂₀ alkyl or C₃₋₂₀ alkenyl ester of (meth)acrylate. For example, the ethylenic unsaturated monomer may be methyl methacrylate, methyl acrylate, ethyl(meth)acrylate, butyl(meth)acrylate, 2-ethylhexyl(meth)acrylate, benzyl(meth)acrylate, lauryl(meth)acrylate, oleyl(meth)acrylate, palmityl(meth)acrylate, or stearyl(meth)acrylate, which may be used alone or in combination of at least two thereof.

Contents of the respective monomers of the copolymer may be suitably changed depending on the composition of the copolymer, and thus the present invention is not limited thereto. According to an exemplary embodiment of the present invention, the copolymer may include methyl methacrylate, butyl acrylate and methacrylic acid, which are mixed in a weight ratio of 80 to 95:0 to 95:5 to 20.

The core layer may have a diameter of 50 to 1000 nm.

The shell layer polymer may use any one capable of maintaining a shape of the particle during the preparation without limitation.

For example, the shell layer polymer may be formed in a double-layered structure including a middle layer polymer polymerized from an ethylenic unsaturated monomer, and an outer layer polymer polymerized from a hydrophobic monomer and surrounding the middle layer polymer, and may include more functional layers in some cases.

The ethylenic unsaturated monomer may be methyl methacrylate, methyl acrylate, ethyl(meth)acrylate, ethyl acrylate, butyl acrylate, butyl(meth)acrylate, 2-ethylhexyl(meth)acrylate, 2-ethylhexyl acrylate, benzyl(meth)acrylate, benzyl acrylate, lauryl(meth)acrylate, lauryl acrylate, oleyl(meth)acrylate, palmityl(meth)acrylate), or stearyl(meth)acrylate, which may be used alone or in combination of at least two thereof.

In the copolymer including the monomer, contents of the respective monomers of the copolymer may be suitably changed according to the composition thereof, but the present invention is not particularly limited. According to an exemplary embodiment of the present invention, the copolymer may include methyl methacrylate, butyl acrylate and methacrylic acid, which are mixed in a weight ratio of 80 to 100:0 to 15:0 to 5.

The hydrophobic monomer may be styrene, vinyl benzene, divinyl benzene, vinyl toluene, ethylene, vinyl acetate, vinyl chloride, vinylidene chloride, acrylonitrile, or (meth)acrylamide, which may be used alone or in combination of at least two thereof.

When at least two of the compounds are used as the outermost hydrophobic monomer, according to an exemplary embodiment of the present invention, styrene and divinyl benzene may be combined in a ratio of 0 to 100:100 to 0 based on weights thereof.

In the present invention, the polymer capsule in which the organic corrosion inhibitor is encapsulated may have a diameter of 50 to 3,000 nm. When the diameter of the polymer capsule is less than 50 nm, the amount of the encapsulated corrosion inhibitor may be reduced, and when the diameter of the polymer capsule is more than 3,000 nm, usability of a thin film may be degraded.

The present invention also relates to a method of preparing a polymer capsule, comprising:

preparing a core layer polymer polymerized from a monomer including a hydrophilic acid monomer; and

forming a shell layer polymer by adding an organic corrosion inhibitor and a hydrophobic monomer in the presence of the core layer polymer, and encapsulating the organic corrosion inhibitor in a core layer or shell layer polymer.

The method of forming the polymer capsule will be described in detail by operations below.

In the operation of preparing a core layer polymer, known polymerization methods may be used without limitation.

For example, the core layer polymer may be polymerized using distilled water as a reaction mediator by emulsifying a monomer capable of emulsion polymerization and, when necessary, a chain transfer agent using a surfactant, and adding a water-soluble initiator to initiate a reaction. In more detail, the monomer is added to an emulsion emulsified using a surfactant. Here, the inside of a reactor is maintained in a nitrogen atmosphere by inputting nitrogen. Subsequently, a core may be polymerized by heating the reactor to 25 to 100° C. using an oil bath and a heating mantle, and inputting a water-soluble initiator to initiate a reaction.

The monomer capable of emulsion polymerization is described above.

In addition, the surfactant may be an anionic surfactant such as sodium lauryl sulfate, a cationic surfactant such as tetradecyl trimethyl ammonium bromide, hexadecyl trimethyl ammonium bromide, or stearyl trimethyl ammonium chloride, or a non-ionic surfactant such as nonyl phenyl ether. Preferably, the present invention uses a non-ionic surfactant to enhance adhesive property with respect to a substrate when a coating material is used. A reaction ratio of the monomer to the surfactant may be 1:0.001 to 0.2 parts by weight, and preferably, 0.005 to 0.1 parts by weight. If the reaction ratio of the monomer to the surfactant exceeds the above range, the state of the emulsion may become unstable.

In addition, as the water-soluble initiator, a persulfate-based initiator such as ammonium persulfate, sodium persulfate, potassium persulate or lithium persulfate, an azo-based initiator such as 4,4-Azobis(4-cyanovaleric acid) or azobis(2-amidinopropane) dihydrochloride, hydrogen peroxide, or tert-butyl peroxide may be used, and the amount of the initiator used may be 0.1 to 5 parts by weight, and preferably, 0.5 to 2 parts by weight of the amount of the monomer.

In addition, the chain transfer agent may use one conventionally used in emulsion polymerization.

In addition, as an emulsifier used in the emulsion polymerization, a non-ionic emulsifier such as tert-octylphenoxyethylpoly(39)-ethoxyethanol or nonylphenoxyethylpoly(40)ethoxyethanol, sodium lauryl sulfate, sodium dodecyl benzene sulfonate, or tertocylphenoxyethoxypoly(39)ethoxyethyl sulfate may be used.

Meanwhile, to form a middle layer before the operation of forming a shell layer polymer by adding an organic corrosion inhibitor and a hydrophobic monomer in the presence of the core layer polymer, for example, an operation of forming a middle layer polymer polymerized from an ethylenic unsaturated monomer in the presence of the core layer polymer may be further included.

The monomer of the shell layer is described above, and a polymerization method may use the emulsion polymerization described above.

The present invention also relates to a method of preparing a polymeric hollow particle, comprising:

preparing a core layer polymer polymerized from a monomer including a hydrophilic acid monomer;

forming a shell layer polymer by adding an organic corrosion inhibitor and a hydrophobic monomer in the presence of the core layer polymer, and encapsulating the organic corrosion inhibitor in a core layer or shell layer polymer; and

adding a base compound in the presence of the shell layer polymer.

The polymeric hollow particle according to the present invention is a particle which becomes a hollow state by neutralizing a hydrophilic acid group of the core layer of the base compound when the base compound is added after the shell layer polymer is formed in the operation of preparing a polymer capsule, and has no change in surface roughness of a polymer shell.

While the base compound may be ammonia, sodium hydroxide, potassium hydroxide, calcium hydroxide, N,N-dimethylethanolamine, triethanolamine, diethanolamine or triethanolamine morpholine, any compound capable of neutralizing the hydrophilic acid group of the core layer may be used without limitation.

The present invention also relates to a method of forming a pore in a surface of a polymeric hollow particle, comprising:

preparing a core layer polymer polymerized from a monomer including a hydrophilic acid monomer; and

forming a shell layer polymer by adding an organic corrosion inhibitor, a basic compound and a hydrophobic monomer in the presence of the core layer polymer, and encapsulating the organic corrosion inhibitor in a core layer or shell layer polymer.

The method of forming a pore in a surface of a polymeric hollow particle according to the present invention will be described in detail below.

In the operation of preparing a core layer polymer, a known polymerization method may be used without limitation.

A polymeric hollow particle in which an organic corrosion inhibitor is encapsulated in a core layer or a shell layer polymer may be prepared by polymerizing the shell layer polymer using the above-described emulsion polymerization.

When a base compound capable of neutralizing a core layer in the polymerization of the shell layer polymer is added, the base compound may be easily diffused into a hydrophilic acid group of a core layer polymer, thereby generating a high osmotic pressure, and a large amount of water may be absorbed to the core layer polymer. In addition, the organic corrosion inhibitor present in the core layer may be released due to increased basicity, which is caused by a different partition coefficient with respect to a polymer of a material according to basicity. Since such migration of a material can cause the migration of water and the base compound to the polymer and the organic corrosion inhibitor in the polymerization of a hydrophobic monomer on a surface of the core layer and thus the shell polymer is considerably transformed, a pore may be formed in the shell layer polymer. In this process, as the core layer polymer is swollen, and a surface area and pore size are increased, the pore size of the polymeric hollow particle may be 10 to 50 nm, and the surface area may be 10 to 100 m²·g⁻¹.

A kind of the base compound is as described above.

The present invention also relates to a corrosion-resistant coating composition including a polymer capsule according to the present invention and a base resin composition.

The coating composition according to the present invention may be used for surface treatment of a steel sheet, and may be used to form a steel sheet having enhanced corrosion resistance by releasing a corrosion inhibitor encapsulated in the polymer capsule outside due to a pH change in a corrosive environment.

The polymer capsule may be included at 5 to 60 parts by weight based on 100 parts by weight of the coating composition in consideration of the corrosion resistance of the steel sheet. When the content of the polymer capsule is less than 5 parts by weight, the effect of corrosion resistance may be decreased, and when the content of the polymer capsule is more than 60 parts by weight, density of a coating film may be degraded due to a relatively low content of a base resin.

The base resin may be at least one selected from the group consisting of a urethane resin, an acryl resin, an epoxy resin, an ester resin and an olefin resin.

Due to strong water resistance, drug resistance, acid resistance and base resistance and a smooth and hard coating film formed by the urethane resin, the urethane resin may be widely used by coating a steel sheet or an aluminum sheet to prevent scratches of its surface or provide chemical resistance. Therefore, any urethane resin conventionally used in the art for such purposes may be used.

In addition, when being used alone, the conventional urethane resin has a limitation in realization of a smooth and hard coating property, and thus the urethane resin according to the present invention may be used in combination of a soft urethane-based resin and a hard urethane-based resin.

In this case, the soft urethane-based resin may be included at 5 to 95 parts by weight based on the solid content of the urethane resin. When the solid content of the soft urethane-based resin is less than 5 parts by weight, processibility may be enhanced but thermal resistance and water degradation resistance may be decreased, and when the solid content of the soft urethane-based resin is more than 95 parts by weight, processibility may not be enhanced, and corrosion resistance may be greatly decreased.

The soft urethane-based resin may be a polyurethane resin prepared from isoprene diisocyanate such as a polyurethane dispersion resin or a polyethylene modified polyurethane resin, a dibasic acid and a polyalcohol, or a polyurethane resin prepared from an acryl polyol such as an acryl-urethane resin or a polyethylene-acryl modified polyurethane resin and polyisocyanate.

Here, the polyalcohol may be an acryl polyol, polyesterpolyol, polyetherpolyol, polyolefin-based polyol, or a mixture thereof.

In addition, the soft urethane-based resin may have a molecular weight of 5,000 to 300,000. When the molecular weight of the soft urethane-based resin is less than 5,000, processibility may be greatly decreased, and when the molecular weight of the soft urethane-based resin is more than 300,000, stability of a solution may be degraded.

Meanwhile, the hard urethane-based resin may be a polyurethane resin prepared from a polycaprolactone polyol or polycarbonate polyol and diisocyanate, particularly, paraphenyldiisocyanate; a polyurethane resin prepared from 4,4′-bis(ω-hydroxyalkyleneoxy)biphenyl and methyl-2,6-diisocyanatehexanoate; or a polyurethane resin having an acetal bond.

The hard urethane-based resin may have a molecular weight of 200,000 to 2,000,000. When the molecular weight of the hard urethane-based resin is less than 200,000, there may be no enhancement in processibility, and when the molecular weight of the hard urethane-based resin is more than 2,000,000, stability of a solution may be degraded, and viscosity of a resin solution may be increased, and thus workability may be degraded.

Meanwhile, the acryl resin is widely used for surface treatment of a metal due to excellent high temperature and high humidity resistance, cold resistance and processibility, and low cost. As the acryl resin capable of being used in the present invention, an acryl-based resin polymerized in a conventional monomer composition including carboxylic acids as to be soluble in water may be used. The acryl-based resin monomer may be, but is not limited to, methyl(meth)acrylate, ethyl(meth)acrylate, isopropyl(meth)acrylate, normalbutyl(meth)acrylate, isobutyl(meth)acrylate, 2-ethylhexyl(meth)acrylate, hydroxypropyl(meth)acrylate. stearyl(meth)acrylate, or hydroxybutyl(meth)acrylate.

The acryl resin may have a molecular weight of 50,000 to 2,000,000. When the molecular weight of the acryl resin is less than 50,000, there may be no enhancement in processibility, and when the molecular weight of the acryl resin is more than 2,000,000, stability of a solution may be degraded, and viscosity of a resin solution may be increased, and thus workability may be degraded.

The epoxy resin is widely used in a coating material formed of a metallic material due to an excellent adhesive property, corrosion resistance and top coatability. The epoxy resin capable of being used in the present invention may be a bisphenol A-type resin, a bisphenol F-type resin or a novolac resin. The epoxy resin may have a molecular weight of 500 to 25,000. When the molecular weight of the epoxy resin is less than 500, it may be difficult to ensure processibility due to an increased crosslinking density, and when the molecular weight of the epoxy resin is more than 25,000, the resin may be difficult to dissolve in water, and corrosion resistance may be degraded due to a decrease in crosslinking density of a cured coating film.

The ester resin is widely used as a metal surface treating material due to excellent curability, drug resistance, thermal resistance and plasticity, and an excellent adhesive property to an organic material. The ester resin capable of being used in the present invention may be a polyester resin prepared from maleic anhydride, isophthalic acid, terephthalic acid, tetrahydrophthalic anhydride, methyltetrahydrophthalic anhydride, adipic acid or pimaric acid, an ethyleneglycol modified ester resin, a propyleneglycol modified ester resin or a neopentylglycol modified ester resin.

The ester resin may have a molecular weight of 2,000 to 20,000. When the molecular weight of the ester resin is less than 2,000, processibility becomes poor due to an increase in crosslinking density, and when the molecular weight of the ester resin is more than 20,000, cost increases, salt water resistance becomes poor due to the increase in crosslinking density, and corrosion resistance is degraded.

Among binder resins, olefin rein has an effect on prevention of scratches on a coated surface after metal surface treatment is done due to strong water resistance, acid resistance and salt water resistance, and hard coating. The olefin resin capable of being used in the present invention may be a water-soluble polyolefin resin, and preferably, polyethylene, a vinyl modified poly ethylene resin, a polyvinyl butylene resin, a polyvinyl chloride copolymer resin, a polyvinyl acetate copolymer resin, or a polyvinyl alcohol resin. The olefin resin may have a molecular weight of 50,000 to 2,000,000. When the molecular weight of the olefin resin is less than 50,000, it is difficult to ensure processibility due to the increase in crosslinking density, and when the molecular weight of the olefin resin is more than 2,000,000, the olefin resin may be difficult to be dissolved in water and precipitated, and corrosion resistance may be degraded due to the decrease in crosslinking density of a cured coating film.

The corrosion-resistant coating composition according to the present invention may further include hardness ions including a calcium ion and a zinc ion to enhance the effects of the corrosion inhibitor.

As a material for providing the hardness ions, calcium exchange silica (product name: Shieldex® AC3, Shieldex® AC5, Shieldex® C303, etc.), calcium phosphate, calcium nitrate, calcium sulfate, zinc phosphate, or zinc nitrate may be used, but the present invention is not particularly limited thereto.

The present invention also relates to a corrosion-resistant steel sheet with a corrosion resistant resin layer formed on one or both surfaces of the steel sheet by coating the corrosion-resistant coating composition according to the present invention.

The steel sheet to which the coating composition according to the present invention may be reacted to the pH change generated in corrosion, and thus a corrosion inhibitor in a nano-capsule included in the coating composition may be released to a surface of the steel sheet, thereby enhancing corrosion resistance of the steel sheet.

As an applicable steel sheet according to the present invention, a zinc-based electroplated steel sheet such as a galvanized steel sheet, a zinc-nickel plated steel sheet, a zinc-iron plated steel sheet, a zinc-titanium plated steel sheet, a zinc-magnesium plated steel sheet, a zinc-manganese plated steel sheet or a zinc-aluminum plated steel sheet, a hot-dip metal coated steel sheet, an aluminized steel sheet, a plated steel sheet containing cobalt, molybdenum, tungsten, nickel, titanium, aluminum, manganese, iron, magnesium, tin, copper or a mixture thereof as a hetero metal or impurity in a plated layer thereof, a plated steel sheet formed by dispersing an inorganic material such as silica or alumina in a plated layer thereof, an aluminum alloy sheet containing silicon, copper, magnesium, iron, manganese, titanium, zinc or a mixture thereof, a cold-rolled steel sheet, or a hot-rolled steel sheet may be used. In addition, a multi-layered plated sheet to which at least two kinds of metals are sequentially plated may also be used.

A method of coating the coating composition is not particularly limited, and the coating composition may be coated on the steel sheet by a method such as application with a roll coater, application with a wringer roll, dipping and application by air-knife wiping, application with a bar coater, spraying, or brushing. In addition, drying after the application may be performed according to a conventional method.

In addition, the thickness of the corrosion resistant coating resin layer is not particularly limited, and may be formed to a thickness of 2 μm or less because there may be a problem of processibility as the thickness of the resin layer is increased.

Hereinafter, the present invention will be described in further detail with reference to Examples according to the present invention, but the scope of the present invention is not limited to the following Examples.

Examples As a target material for capsulation, phosphoric acid partial esters (PAPEs) were used. Four kinds of PAPEs, for example, phosphoric acid mono-butyl ester (Daihachi chemical industry Co., Ltd., Japan), phosphoric acid di-butyl ester (Tokyo chemical industry Co., LTD., Japan), phosphoric acid 2-ethylhexyl ester (mono- or di-mixture) (Tokyo chemical industry Co., LTD., Japan) and phosphoric acid di(2-ethylhexyl) ester (Tokyo chemical industry Co., LTD., Japan), were used.

In addition, as a monomer of a structural polymer, methyl methacrylate (MMA), butyl acrylate (BA), methacrylic acid (MAA) or styrene was used (the monomers are produced by Samchun pure chemical Co. LTD).

Ammonium nonyl phenol ether sulfate (Rhodapex Co-436, supplied by Rhodia, North American) was used as an emulsifier, and sodium persulfate (Samchun pure chemical Co. LTD., Korea) was used as a radical polymerization initiator.

Finally, to prepare a polymeric hollow particle, as a base compound for neutralizing a core polymer particle including a carboxylic acid, ammonia (Samchun pure chemical Co. LTD., Korea), triethanolamine (Samchun pure chemical Co. LTD., Korea) and N,N-Dimethylethanolamine (ACROS organic, USA) was employed.

### EXAMPLE 1

### Preparation of Polymer Capsule in Which Phosphoric Acid Partial Ester was Encapsulated

A polymer capsule including a corrosion inhibitor was polymerized by continuous emulsion polymerization.

A standard preparation process for multi-step emulsion polymerization is shown in Table 1. A paddle stirrer, a thermometer, a nitrogen-gas introduction device and a reflux cooler were equipped to a 1,000-ml round bottom flask. 0.037 mol phosphoric acid partial ester was added to 495 g of an emulsion including 19.2 g of acrylate copolymer core particles. A weight ratio of MMA/BA/MAA monomers in a core latex particle was set to 62:31:7. The emulsion was heated to 85° C. at a stirring rate of 200 rpm under a nitrogen atmosphere in the flask. The emulsion was maintained for 30 minutes to sufficiently diffuse the phosphoric acid partial ester into a core polymer matrix. A solution including 0.5 g of sodium persulfate dissolved in 15 g of water was slowly added to the flask. A monomer mixture including 4.2 g of butyl acrylate, 51 g of methyl methacrylate and 1.8 g of methacrylic acid was added to the flask at a rate of 0.95 g/min. Sequentially, a styrene pre-emulsion composed of 38 g of deionized water, 0.33 g of ammonium nonyl phenol ether sulfate, 0.5 g of sodium persulfate and 99 g of styrene was added to the flask at a rate of 2.3 g/min at 85° C. After the addition of the emulsion, the dispersion was maintained at 85° C. for 30 minutes.

TABLE 1
Standard Preparation Method for Multi-
Step Emulsion Polymerization

| | | | | |
|---|---|---|---|---|
| 1) | Distilled water | 435 | g | Temperature: 85° C. |
| 2) | Acrylate copolymer | 60 | g | Stirring: 30 min |
| 3) | Phosphoric acid partial | 0.037 | mol | |
| | ester | | | |
| 4) | Distilled water | 15 | g | Slowly supply (within 5 |
| | | | | min) |
| 5) | Sodium persulfate | 0.5 | g | |
| 6) | Butyl acrylate | 4.2 | g | Temperature: 85° C. |
| 7) | Methyl methacrylate | 51 | g | Supply Rate: 0.95 g · min⁻¹ |
| 8) | Methacrylic acid | 1.8 | g | Maintenance Time: 60 min |
| 9) | Distilled water | 38 | g | Temperature: 85° C. |
| 10) | Surfactant | 0.33 | g | Supply Rate: 2.3 g · min⁻¹ |
| 11) | Sodium persulfate | 0.5 | g | Maintenance Time: 30 min |
| 12) | Styrene | 99 | g | |

Neutralization

| | |
|---|---|
| 28% aqueous ammonia | Temperature: 85° C. |
| (10 g) or | Time: within 30 min |
| 20% aqueous DMEA | (Sequentially or |
| (40 g) or | simultaneously add |
| 20% aqueous TEA | after styrene was |
| (40 g) | supplied) |

### (Investigation of Characteristics)

A diluted dispersion of the prepared capsule was dropped on copper grid-coated 400-mesh carbon. A sample collected on the grid was dried, and maintained overnight in a vacuum oven. The shape of the capsule was observed on a transmission electron microscope (TEM, Phillips CM 200). The surface shape was observed on a scanning electron microscope (SEM, Hitachi SU-6600). Before the SEM test, the sample was coated with 10 nm Pt/Pd. Adsorption and release of nitrogen were performed using BEL BELSORP-minoll, and thereby surface area and pre size of the polymer capsule were measured. Before the adsorption of a nitrogen gas, the sample was deaerated at 50° C. for 6 hours. The content of the phosphoric acid partial ester encapsulated in the polymer capsule was measured by thermogravometric analysis (TGA, Mettler-Toledo 851E). Before the TGA analysis, 5 parts by weight of a CaCl₂ solution was added to the emulsion in a weight ratio of 1:1 to inhibit emulsification of the emulsion, and the polymerized capsule particle was centrifuged to separate. The separated polymer precipitate was dispersed again in distilled water, and centrifuged at least once to remove the phosphoric acid partial ester remaining on an outer surface of the capsule. A small amount the capsules (10 to 20 mg) were heated from 25 to 400° C. at a rate of 10° C./min in a nitrogen atmosphere.

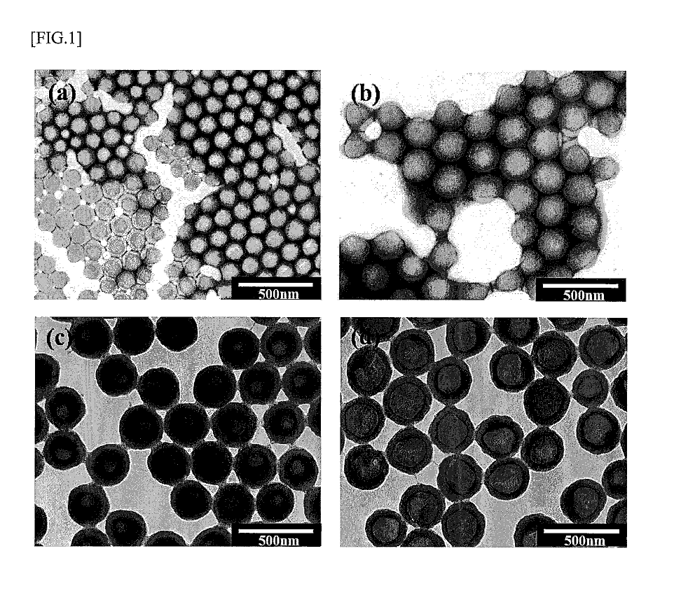

FIG. 1(a) shows a core polymer particle including a large amount of carboxylic acids, and the core polymer particle is surrounded by a relatively hydrophobic polymer compared to the core polymer particle itself. In addition, a shell of the particle is composed of an acrylate copolymer having a different composition.

FIG. 1(b) shows a core particle surrounded by a shell polymer layer, the size of the core particle is approximately 250 nm, and side distribution is quite uniform. These particles are used as cores, thereby forming a capsule surrounded by a shell layer formed of hydrophobic polymerized styrene.

As shown in FIG. 1(c), a core-shell polymeric hollow particle was successfully polymerized by polymerizing a hydrophobic polymer on a core including a hydrophilic acid through maximization of kinetics and thermodynamic factors.

Finally, as shown in FIG. 1(d), the polymer particle had a hollow formed by osmotic expansion. To create a hollow formation environment, the core polymer was neutralized using 10 g of 28% aqueous ammonia at a softening point of a shell layer polymer, that is, 93° C.

In addition, as a target material for capsulation, 4 kinds of phosphoric acid partial esters (PAPEs), that is, mono-butyl ester, di-butyl ester, mono(2-ethylhexyl) ester and di(2-ethylhexyl) ester, were used. Due to the difference in alkyl side chain and degree of esterification, a characteristic capsulation behavior is expected. To examine thermodynamic parameters, for example, a partition coefficient and water solubility, with respect to the capsulation behavior, in the beginning of polymerization, the target material was added to an emulsion to encapsulate various PAPEs into the multi-step polymer capsule. The PAPE partition coefficient, water solubility and respective operations of the polymer were obtained by an ALOGPS 2.1 program explained in http://www.vcclab.org/lab/alogps. An n-octanol/water partition coefficient, logP, was determined based on total analysis of a nervous network of a 12908 organic compound which can be used in PHYSPROP database of Syracuse Research Corporation. The partition coefficient and water solubility of the phosphoric acid partial ester were calculated according to the ALOGPS 2.1 program listed in Table 2.

TABLE 2
Partition Coefficient and Water Solubility of Phosphoric Acid
Partial Ester Calculated according to ALOGPS 2.1 Program

| | logP | logS | |
|---|---|---|---|
| Phosphoric Acid | | | |
| Partial Ester | | | |
| mono-butyl ester | 0.44 | −0.78 | (25.08 g/L) |
| di-butyl ester | 1.65 | −0.20 | (13.2 g/L) |
| mono(2-ethylhexyl) ester | 1.64 | −1.48 | (6.97 g/L) |
| di(2-ethylhexyl) ester | 5.15 | −3.75 | (57.74 mg/L) |
| Polymer | | | |
| core | 2.35 | −4.84 | (41.74 mg/L) |
| first polymer shell | 4.02 | −5.36 | (11.36 mg/L) |
| second polymer shell | 10.82 | −8.79 | (insoluble) |

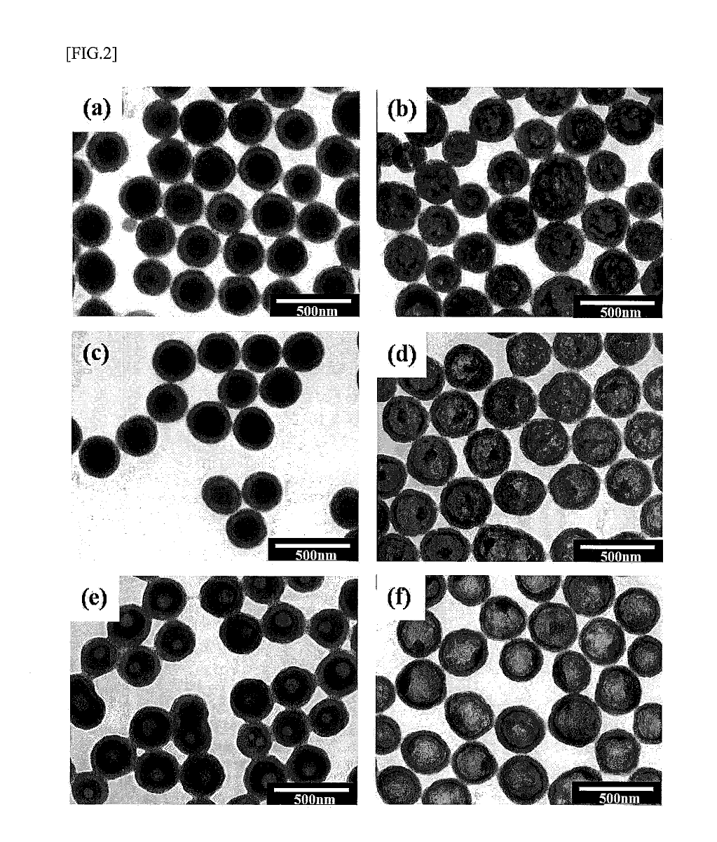

FIG. 2 shows a polymer capsule completed when phosphoric acid partial ester is added to an emulsion in the beginning of polymerization. When phosphoric acid partial esters were added, the emulsion maintained stability during an entire polymerization process.

Meanwhile, as shown in FIG. 1(c), when phosphoric acid partial ester was not used, the polymer capsule in the middle looked brighter than an external shell. However, in FIGS. 2(a) and (c), when phosphoric acid di-butyl ester or mono(2-ethylhexyl) ester was encapsulated in the capsule, the capsule in the middle looked somewhat darker than the external shell. In a TEM image, phosphoric acid partial ester looked darker than another structural polymer due to a relatively higher electron density. In the TEM image, electrons were absorbed or scattered by a specimen, and others were migrated. Flexibility is dependent on the electron density of a material, and determined by atomic weight. For this reason, opposite to di(2-ethylhexyl) ester, it is considered that phosphoric acid di-butyl ester and mono(2-ethylhexyl) ester are present in a relatively hydrophilic core polymer.

As shown in FIG. 2(e), in the case of phosphoric acid di(2-ethylhexyl) ester, the core polymer looked brighter than the external shell, similar to a capsule not including PAPE. It is considered that phosphoric acid di(2-ethylhexyl) ester is included in a hydrophobic acrylate copolymer or polystyrene shell, not in a core polymer matrix.

Subsequently, when an emulsion is neutralized at 85° C. using 10 g of 28% aqueous ammonia solution, generation of hollows is induced due to expansion of a hydrophilic core particle. In detail, a base compound forms a polyelectrolyte with a carboxylic acid of the core polymer. Due to the osmotic pressure induced thereby, water was absorbed into the capsule. The core polymer was expanded in a complete spherical shape due to the formation of a uniform polymer electrolyte, as shown in FIG. 1(d). However, when the phosphoric acid partial ester is included in the core polymer matrix, it may be interacted with a neutralized base. In other words, the base may form the polyelectrolyte with phosphoric acid partial ester in addition to a carboxylic acid. Therefore, as shown in FIGS. 2(b), (d) and (f), the core polymer may not be uniformly expanded by transforming the spherical shape.

To measure the relative content of the phosphoric acid partial ester in the polymer capsule, TGA (Thennogravimetric analyzer) was performed. As in the representative example, DSC scan of phosphoric acid di(2-ethylhexyl) ester and TGA scan of the separated capsule are shown in Table 3(A).

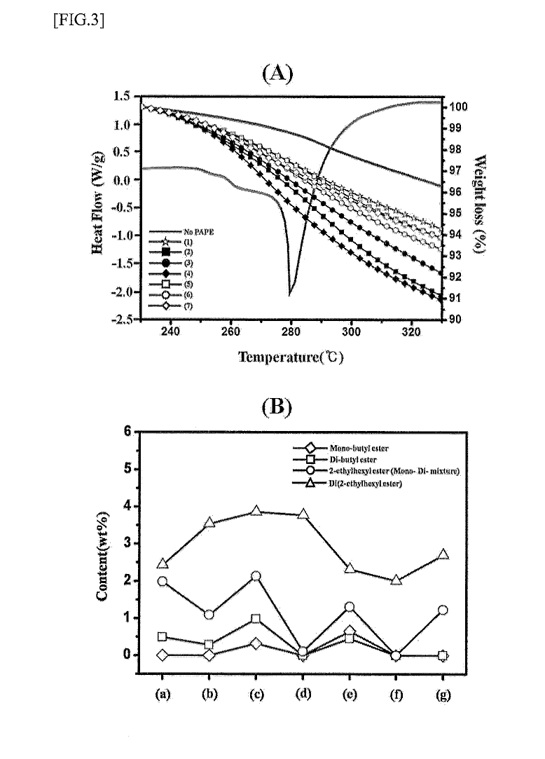

A DSC graph is an endothermic peak showing evaporation of phosphoric acid di(2-ethylhexyl) ester. Between 230 and 330° C., 83% of di(2-ethylhexyl) ester was evaporated, and weight loss of the polymer capsule was only 5%. According to such a difference, the relative content of di(2-ethylhexyl) ester may be obtained between 230 and 330° C. Contents of other PAPEs in the capsule were measured by the same method as described above, and are shown in FIG. 3(B).

Phosphoric acid di(2-ethylhexyl) ester was the most effectively encapsulated in the polymer capsule. However, phosphoric acid mono-butyl ester and di-butyl ester were rarely encapsulated in the capsule. The tendency of capsulation corresponded to a dispersion characteristic of PAPE. It is considered that capsulation efficiency is dependent on the characteristic of PAPE, that is, a partition coefficient.

### EXAMPLE 2

### Formation of Pore in Polymeric Hollow Particle

Since release kinetics of a capsulation material is dependent on a shell shape including surface area and pore size, it is necessary to suitably control the shape of the polymer capsule. The shape of the polymer shell may be dramatically changed by changing process parameters during osmotic expansion. In the present example, various process parameters were treated in core expansion, and the change in shape of the capsule was investigated.

First, various bases were added to an emulsion, and the change in shape of the capsule was investigated.

Second, to induce swelling of the capsule by base neutralization during styrene polymerization, a base was simultaneously added with a styrene monomer to neutralize the emulsion. The neutralization was performed at the glass transition temperature of polystyrene, 93° C., for 30 minutes in initial supply of the styrene monomer. The subsequent operation is the same as a continuous polymerization operation.

Third, after the polymerization of the styrene monomer was done, the emulsion was neutralized using a base. The base used for neutralization was 10 g of 28% aqueous ammonia, 40g of 20% aqueous N,N-dimethylethanolamine (DMEA) or 40 g of 20% aqueous triethanolamine (TEA). All neutralization was performed at 85 or 93□ for 30 minutes. After the neutralization, a dispersion was maintained at the same temperature as the previous temperature for 30 minutes, cooled to room temperature, and filtered to remove a precipitate.

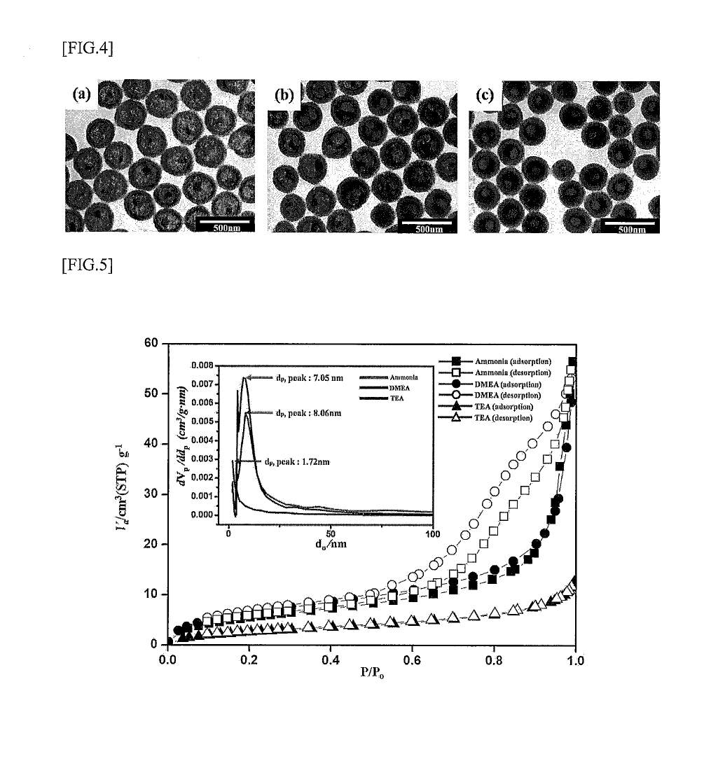

As shown in FIG. 4, to investigate the change in shape according to a kind of the neutralization base, when a polymerized polymer capsule including phosphoric acid 2-methylhexyl ester (mono-. di-mixture) was polymerized at 85□ and neutralized using 28% aqueous ammonia, 20% aqueous DMEA and a 20% aqueous TEA solution, the core polymer neutralized with ammonia was remarkably expanded, and the shape of a shell was significantly changed (refer to FIG. 4(a)). Due to low molecular weight and high basicity of the ammonia, the core polymer including a carboxylic acid may be effectively swollen. Due to osmotic pressure increased by ammonia neutralization, more water may be absorbed into the core polymer.

According to active penetration of water, as shown in FIG. 5, a solid pore may be formed in the shell of the capsule. However, the pore is rarely seen when DMEA and TEA are added after the styrene polymerization. This is caused by an increased molecular weight and decreased basicity.

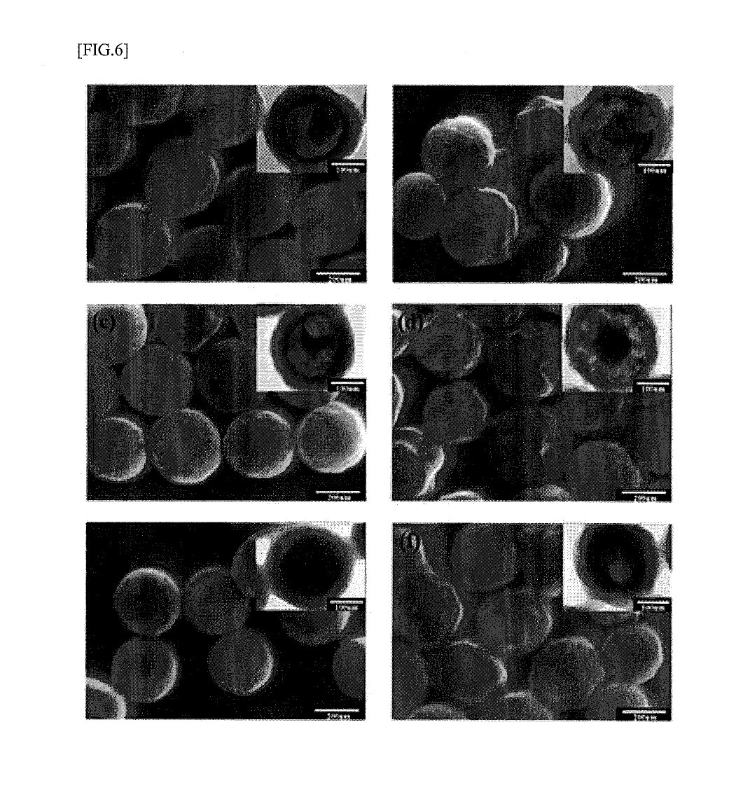

To investigate the change in shape of the capsule, base neutralization was performed at an increased temperature of 93° C. during or after the styrene polymerization. FIG. 6 shows TEM and SEM images of a polymer capsule polymerized by addition of ammonia (a and b), DMEA (c and d) and TEA (e and f) after or during polymerization.

The core polymer may be sufficiently expanded when a styrene monomer and a neutralization base are simultaneously added to a reactor, roughness of the polymer shell was increased, and pore size was also increased. The neutralization base may be easily diffused into a carboxylic acid of the core polymer at the beginning of the styrene polymerization. This is caused by a thin PMMA middle shell polymer. For this reason, high osmotic pressure may be generated, and more water may be absorbed to the core polymer. In addition, due to increased basicity, phosphoric acid partial ester included in a core layer may be released, which is because a partition coefficient with respect to a polymer of a material is changed according to basicity. Such migration of a material was shown in the migration of water and a base compound to the polymer and phosphoric acid partial ester when styrene was polymerized on a surface of a hydrophobic polymer (middle-layer polymer).

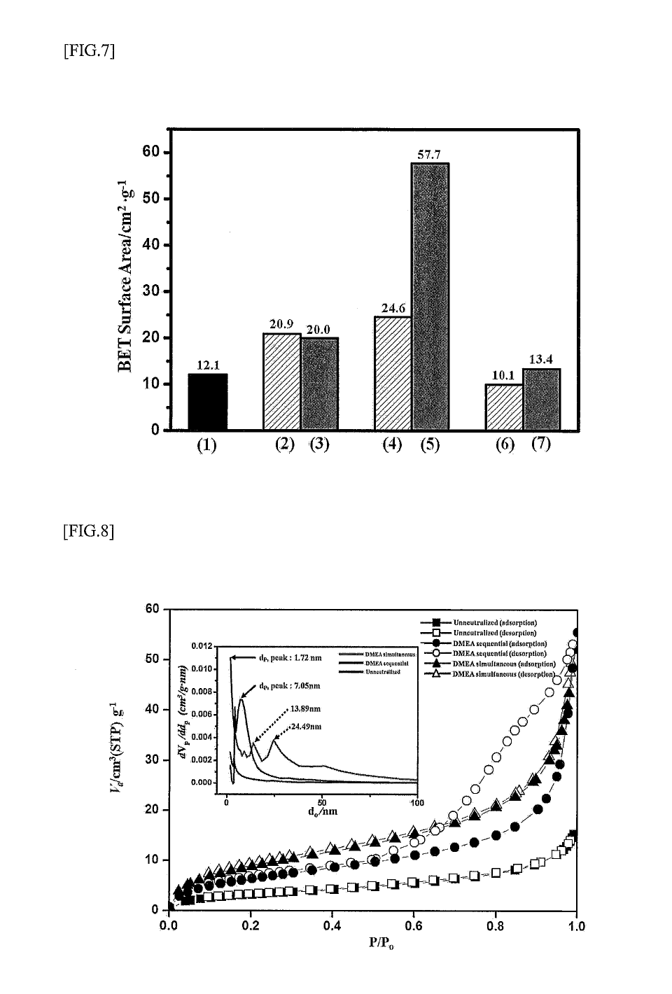

Therefore, a shell polymer was considerably changed in form, and a solid pore was formed in the polymer shell. Particularly, when DMEA was provided to a reactor simultaneously with the styrene monomer, the core polymer was mostly expanded, and surface area and pore size were dramatically increased. When the capsule was simultaneously neutralized by DMEA, the surface area of the capsule was approximately 5 times larger than the standard capsule, which is 57.712 m²·g⁻¹, and pores having a size of approximately 25 nm were formed (refer to FIGS. 7 and 8). It was expected that the expanded pore and increased surface area would affect the release kinetics of the capsulated active material.

### EXAMPLE 3

### Self-Healing Behavior of Coating Thin Film Including Polymer Capsule According to the Present Invention

To evaluate self-healing efficiency of a coating thin film including the polymer capsule according to the present invention, pH-dependent release behavior of the polymer capsule including phosphoric acid partial ester was investigated from aqueous solutions having acid and base pHs adjusted by adding HCl or NaOH.

0.5 g of the polymer capsules were added to each of the acid and base solutions. In a predetennined time, the capsule was filtered using a vacuum filter including a 0.2-μm membrane paper. A concentration of the filtrate was analyzed by Thermo Elemental IRIS Advantage inductively coupled plasma atomic emission spectroscopy (ICP-AES).

To evaluate self-healing performance of the coating layer, a cyclic corrosion test was performed on a coated surface of a specimen artificially damaged using a sharp scriber. The cyclic corrosion test was as follows: Salt spray (35° C., 2 hours)→Dry (25% RH, 60° C., 4 hours)→Humid (95% RH, 60° C., 2 hours)

After the test was performed 9 times, the coated surface was observed on an optical microscope.

When the thin film was mechanically damaged, a metal itself was exposed to a corrosive environment, thereby inducing dramatic changes in environment such as increase in pH, formation of metal ions and penetration of water into the coated thin film. Such changes cause the diffusion of phosphoric acid partial ester from the capsule. After the phosphoric acid partial ester was released from the coating material, a composite passivation thin film composed of phosphoric acid partial ester, a metal ion and a hardness ion, was formed on a damaged part.

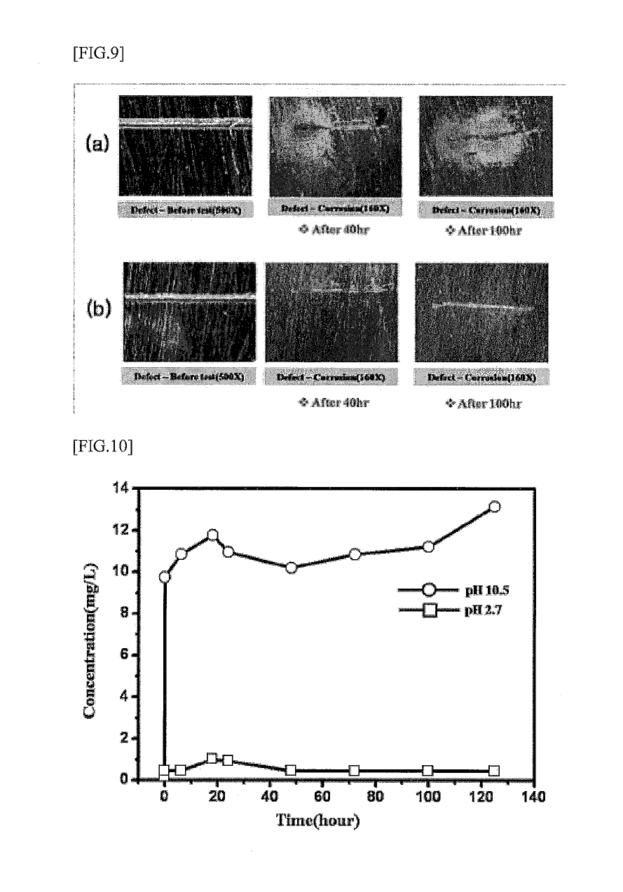

In addition, FIG. 9 shows a surface of a cold-rolled steel sheet before and after a corrosion solution was continuously dropped on the damaged part every 5 hours, and FIG. 10 is a graph showing pH-dependent release behavior of the polymer capsule according to the present invention including phosphoric acid di(2-ethylhexyl) ester.

As a polymer capsule having an encapsulated organic corrosion inhibitor according to the present invention is used as a coating material for a steel sheet, the corrosion inhibitor was released to the steel sheet in a corrosive environment, and thus the steel sheet can have enhanced corrosion resistance.

While the invention has been shown and described with reference to certain exemplary embodiments thereof, it will be understood by those skilled in the art that various changes in form and details may be made therein without departing from the scope of the invention as defined by the appended claims.

1. A polymer capsule, comprising:
a core layer polymer polymerized from a monomer including a hydrophilic acid monomer; and
at least one shell layer polymer surrounding the core,
wherein an organic corrosion inhibitor is encapsulated in the core layer or shell layer polymer.

2. The polymer capsule according to claim 1, wherein the organic corrosion inhibitor includes at least one selected from the group consisting of a phosphoric acid-based corrosion inhibitor, a phosphonic acid-based corrosion inhibitor, a carboxyl group-containing corrosion inhibitor, and an azole-based corrosion inhibitor.

3. The polymer capsule according to claim 1, wherein the core layer polymer is a polymer polymerized from a hydrophilic acid monomer, or a copolymer of a hydrophilic acid monomer and an ethylenic unsaturated monomer.

4. The polymer capsule according to claim 1, wherein the shell layer polymer includes a middle layer polymer polymerized from an ethylenic unsaturated monomer, and
an outer layer polymer polymerized from a hydrophobic monomer and surrounding the middle layer polymer.

5. A method of preparing a polymer capsule, comprising:
preparing a core layer polymer polymerized from a monomer including a hydrophilic acid monomer; and
forming a shell layer polymer by adding an organic corrosion inhibitor and a hydrophobic monomer in the presence of the core layer polymer, and encapsulating the organic corrosion inhibitor in a core layer or shell layer polymer.

6. The method according to claim 5, further comprising:
forming a middle layer polymer polymerized from an ethylenic unsaturated monomer in the presence of the core layer polymer.

7. A method of preparing a polymeric hollow particle, comprising:
preparing a core layer polymer polymerized from a monomer including a hydrophilic acid monomer;
forming a shell layer polymer by adding an organic corrosion inhibitor and a hydrophobic monomer in the presence of the core layer polymer, and encapsulating the organic corrosion inhibitor in a core layer or shell layer polymer; and
adding a base compound in the presence of the shell layer polymer.

8. A method of forming a pore in a surface of a polymeric hollow particle, comprising:
preparing a core layer polymer polymerized from a monomer including a hydrophilic acid monomer; and
forming a shell layer polymer by adding an organic corrosion inhibitor, a base compound and a hydrophobic monomer in the presence of the core layer polymer, and encapsulating the organic corrosion inhibitor in a core layer or shell layer polymer.

9. A corrosion-resistant coating composition, comprising:
a polymer capsule according to claim 1; and
a base resin composition.

10. The coating composition according to claim 9, wherein the polymer capsule is included at 5 to 60 parts by weight based on 100 parts by weight of the total composition.

11. The coating composition according to claim 9, wherein the base resin includes at least one selected from the group consisting of a urethane resin, an acryl resin, an epoxy resin, an ester resin and an olefin resin.

12. The coating composition according to claim 9, wherein the coating composition further comprises at least one selected from the group consisting of a calcium ion and a zinc ion.

13. A corrosion-resistant steel sheet with a corrosion resistant resin layer formed on one or both surfaces of the steel sheet by coating the corrosion-resistant coating composition according to claim 9.

14. The steel sheet according to claim 13, wherein the steel sheet is selected from the group consisting of a cold-rolled steel sheet, a galvanized steel sheet; a zinc-based electroplated steel sheet; a hot dip galvanized steel sheet; an aluminized steel sheet; a plated steel sheet containing an impurity or hetero metal such as cobalt, molybdenum, tungsten, nickel, titanium, aluminum, manganese, iron, magnesium, tin, copper or a mixture thereof in a plated layer; an aluminum alloy sheet to which silicon, copper, magnesium, iron, manganese, titanium, zinc or a mixture thereof is added; a galvanized steel sheet to which a phosphate is coated; and a hot-rolled steel sheet.
